(19) United States
(12) Patent Application Publication
(10) Pub. No.: US 2006/0162579 A1
(43) Pub. Date: Jul. 27, 2006

(54) Systematic method and apparatus for cutting, filling and grilling of bake good products

(75) Inventors: Susan A. Sinatra, Williamsville, NY (US); Michael A. Cocco, Williamsville, NY (US); Frederick W. Braun, Younstown, NY (US)

Correspondence Address: Kevin D. McCarthy;Roach Brown McCarthy & Gruber, P.C., 420 Main Street - 1620 Liberty Building, Buffalo, NY, 14202, US

(73) Assignee: Sinco LLC

(21) Appl. No.: 11/188,589

(22) Filed: Jul. 25, 2005

Related U.S. Application Data
(60) Provisional application No. 60/647,364, filed on Jan. 26, 2005.
(60) Provisional application No. 60/649,705, filed on Feb. 3, 2005.

(51) Int. Cl. A23N 4/04

(52) U.S. Cl. 99/537

(57) ABSTRACT

The present invention is an apparatus for cutting at least one yeast and/or yeast-like and/or leaven containing product. The apparatus comprises a positioning device, a boring conduit and a negative pressure. The positioning device receives at least one yeast and/or yeast-like and/or leaven containing product. The boring conduit has a distal end and a proximal end. The proximal end is attached to a motor that allows the distal end to at least penetrate into and out of the one yeast and/or yeast-like and/or leaven containing product on the positioning device to form the outer perimeter of a cavity within the one yeast and/or yeast-like and/or leaven containing product. The negative pressure is maintained within the boring conduit and removes at least some of the material within the outer perimeter of the cavity.

### CLAIM OF PRIORITY

This application claims priority to U.S. provisional patent application Ser. No. 60/647,364, filed on Jan. 26, 2005; and U.S. provisional patent application Ser. No. 60/649,705, filed on Feb. 3, 2005.

The present invention is directed to a systematic cut, grill and fill method and apparatus for cutting a cavity in food products and filling the cavity with food products such as but not limited to vegetables, prepared foodstuffs, and desert items for the purpose of filling the food product with a one or a multitude of eatable fillings.

### BACKGROUND OF THE INVENTION

Rolls, bread and other yeast and/or yeast-like and/or leaven containing products are used in the main courses, desserts, snacks, and appetizers. An example of a lunch main course is a Egg Salad sandwich. The chopped hard boiled egg is mixed with mayonnaise to form it into a particulate and sauce-like material. Meanwhile, a roll is cut into half or alternatively sliced to make an opening to receive the particulate and sauce-like material. The maker of the Egg Salad sandwich inserts the particulate and sauce-like material into the opening of the roll or onto the cut half of the roll. The user of the sandwich brings the sandwich to their mouth and hopes that the particulate and sauce-like material of the egg salad sandwich remains in the roll and does not drip or leak on to the person, on the table, or on the floor.

The present invention solves that problem and much more for yeast and/or yeast-like and/or leaven containing products that can contain edible fillings therein.

### SUMMARY OF THE INVENTION

The present invention is an apparatus for cutting, grilling and filling a yeast and/or yeast-like and/or leaven containing product without affecting integrity of the top, bottom or sides of product. The apparatus comprises a positioning device, a boring conduit and a negative and/or positive pressure. The positioning device receives at least one yeast and/or yeast-like and/or leaven containing product. The boring conduit has a distal end and a proximal end. The proximal end is attached to a motor that allows the distal end to at least penetrate into and out of the yeast and/or yeast-like and/or leaven containing product on the positioning device to form the outer perimeter of a cavity within the-yeast and/or yeast-like and/or leaven containing product. The negative and/or positive pressure is maintained within the boring conduit and removes at least some of the material within the outer perimeter of the cavity.

### BRIEF DESCRIPTION OF THE FIGURES

FIG. 1 shows the hollow boring device that creates the cavity in a roll.

FIG. 2 shows the power head assembly that supports and supplies rotational power to the boring tube.

FIG. 3 is a representation of two nest assemblies suitable for the cutting of round, oval and long rolls and or other food products.

FIG. 4 shows the orientation of one power head and two nests.

FIG. 5 shows a typical enclosure (21) that houses the power head and nests.

FIG. 6 depicts the filling station.

FIG. 7 shows a grilling station.

FIG. 8 shows the cutter tube (FIG. 1) mounted in the power head (FIG. 2).

### DETAILED DESCRIPTION OF THE INVENTION

The first step in the process takes place at the temperature controlled Cutting Station. An electrically controlled motorized boring device hollows out a food product (example herein referred to as frozen rolls), normally a yeast and/or yeast-like and/or leaven containing product. The frozen rolls are automatically loaded into nests where they are securely held while they are moved laterally relative to the boring system.

When in proper alignment, axial movement between the nest and the boring device causes the cutting device to pierce one end of the roll. The cutter then creates a cylindrical pocket or cavity in the interior of the roll as it cuts further into the roll. When processing long narrow rolls, the cutter is then withdrawn from the frozen roll and the nest and roll can move freely away. When processing round (wide) rolls, the cutter remains stationary within the roll and the nest is moved latterly relative to the cutter prior to being withdrawn from the roll. The lateral movement of the cutting system elongates the cavity forming an oval shaped void in the roll.

1. The rolls are frozen to permit rapid boring of the baked good product without distorting, tearing or piercing the sides or far end of the roll. It also permits the cuttings to be removed in small crumb like particles.

2. When cutting either round or long rolls, the integrity of the roll cavity is carefully maintained through the cutting process to preclude any penetration or thinning of the outer shell of the roll, thereby preventing any leakage of the edible filling when filled.

3. A cutting blade is attached to the outboard end of the tubular boring device. To assist in the boring of round rolls several additional spiral helical blades are placed on the outer surface of the tube. The end blade bores into the roll when it is moved in the axial direction and the spiral blades cut an oblong cavity in the roll when it is moved laterally. The cutting action of the blades creates small particles of fibrous debris that is discarded.

4. A vacuum suction is drawn in the boring tube during the cutting process. The vacuum removes the loose fiber from the roll interior as it is hollowed out by the boring action of the cutter. The vacuum collects the fiber debris for subsequent disposal after the cutting action is completed.

5. The cutting system has a built in refrigeration system that maintains the frozen state of the rolls before, during and after the hollowing out process.

6. The machine has an air filtering system to maintain cleanliness of the boring operation.

7. The cutting system can be adjusted for different types and styles of food products.

Operational example: An operator loads the Cutting Station with a supply of frozen uncut rolls. The uncut rolls are transferred automatically to nests where they are secured in a known position and are ready for cutting. The Cutting Station automatically hollows out the roll by moving the nest and the boring cutter axially and laterally as required to make the desired size and shape of cavity. The nest then releases the roll and they are automatically moved to freezer storage for subsequent usage. The automatic operation of the Cutting Station permits the operator to accumulate an inventory of frozen cut rolls for subsequent use.

The second (or sometimes a later) step features a Grilling Station that grills the hollowed out rolls.
1. Once the frozen rolls have reached the retail outlet, the grill machine is used to transform the frozen rolls with a cavity into a grilled tasty receptacle ready for filling.
2. The roll is placed on a conveyor and is transported through a heated grilling chamber. The chamber temperature, conveyor speed and time in the grill is regulated to provide the required amount of heating to grill the roll.
3. After the rolls have passed through the grilling process the rolls are automatically deposited into thermostatically controlled warmer drawers until needed for filling.

In the third (or possibly the second) step of the process, a foodstuff is injected into the cavity of the roll. A variety of prepared fillings are stored in the temperature controlled section of the filling station. Each filling is stored in a bladder-type bag which is designed for easy installation in the filling station.

1. The filling station is a temperature controlled cabinet that contains the bladder and associated filling equipment.
2. The bladder is designed to fit into the cabinet and has a single nozzle (flexible tube) leading from the bottom end.
3. The nozzle extends from the bladder a sufficient length to permit the free end to be inserted in the roll cavity (created in step one).
4. The filling material is pumped into the cavity by the action of a multi-roller (peristaltic style) pump that is automated to transfer a preset quantity of filling into the roll cavity.
5. Separate rollers apply a squeezing action to the sides of the bladder forcing the contained filling towards the bottom and thereby, keeping the pump primed.
6. The filling material is completely contained in the bladder system and never contacts the filling station machinery. This ensures that the maintenance of sanitary conditions is always maintained within the system.
7. When not in service, the nozzle may be capped and returned to the Filling Station cabinet where temperature controlled conditions will help preserve the filling material.
8. When filled, the roll and/or other filled food product is ready for consumption by a purchaser.
   Advantages and Problems Solved

This automated sandwich system allows the creation of unique non-spill sandwiches and deserts. The challenges faced by the food industry are answered by this system in that it helps ensure:
1. Sanitary food product handling
2. Portion control
3. Nutritional value control
4. Quality control
5. Reduction of waste that result from spoilage and the mishandling of food product
6. Reduction of labor costs as a result of automation of the processes
7. Customer ability to consume without worry of spillage
8. Allows a fully automated sandwich making process to take place in a limited space.
9. Gives the ability to serve muli-ethnic fillings to meet multi-cultural demands.
   The Cutting Station.

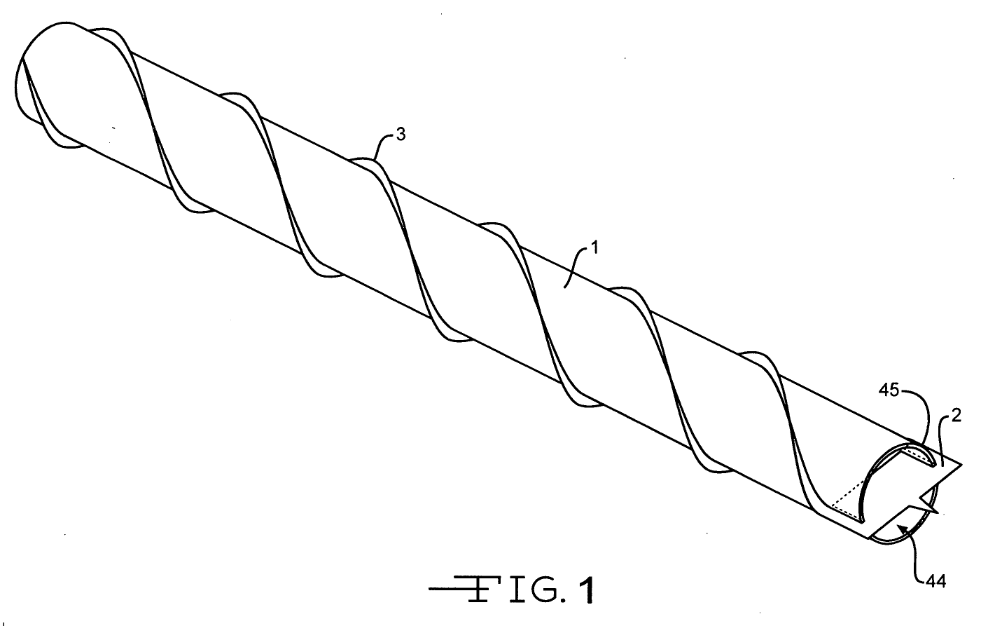

FIG. 1 shows the hollow boring device that creates the cavity in the roll. The thin-wall stainless steel boring tube, that holds the cutting blades, is shown as part (1). The diameter of the tube is selected depending on the size of cavity desired in the roll. The end blade used for axial cutting is depicted as part (2) and can be any conventional shape that creates the desired cavity. In one embodiment, the end blade extends both beyond the end of the tube and outer surface of the tube.

The larger dimension of the end blade cuts a hole in the roll that is larger in diameter than the diameter of the tube.

The difference in diameters results in the creation of an annular space between the tube outer surface and the surface of the hole. The annular space is used to act as a conduit to convey the debris from the cutting process (crumbs) towards the point of disposal. A vacuum is pulled on the inside 44 of the boring tube. The vacuum system causes an axial flow of air towards the end blade in the annular space described above. The axial flow of air carries the crumbs to the open end 45 of the tube. The airflow then carries the crumbs down the center of the tube for subsequent disposal.

The spiral blades that are used for cutting oblong cavities in round rolls are shown as part (3). The spiral blades are attached to the outer surface of the boring tube and have a height similar in dimension to the distance the end blade extends beyond the outer surface of the tube. The spiral blades also help direct the crumbs towards the open end of the tube.

The pitch of the spiral blades is dependent on the type of roll being processed and can be omitted if only cylindrical cavities are to be created in rolls using this cutter. Different sizes of boring tubes and end blades are available for cutting different cavity configurations in different types of rolls.

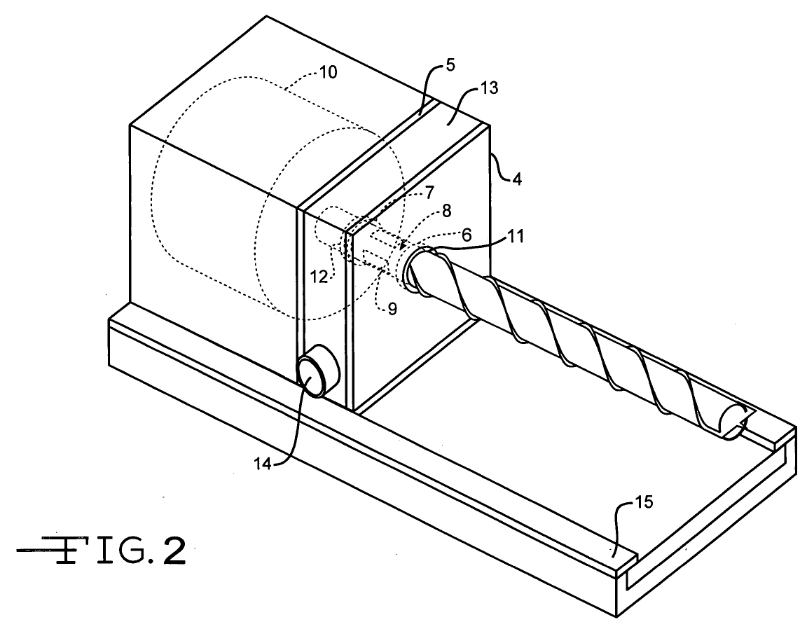

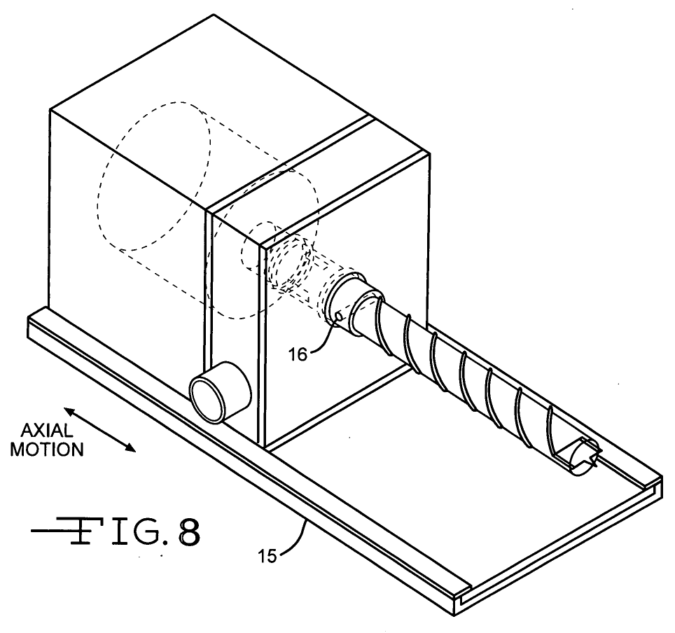

FIG. 2 shows the power head assembly that supports and supplies rotational power to the boring tube. The outboard endplate (4) and inboard endplate (5) have large diameter bearings (6) and (7) that support the adaptor shaft (8). The adaptor shaft has large openings (9) cut into the region between bearings that provide a passageway from inside the adaptor shaft to the outside. A variable speed electric gearmotor (10) is attached to the adaptor shaft providing it with the power to rotate at various speeds. Both the outboard and inboard bearings have air seals (11 and 12) that minimize the flow of air that moves around and through the bearings. The endplates are connected through a wide spacer (13), which along with the endplates (4) and (5) forms a hollow box. A connection (14) that allows a vacuum to be drawn on the interior box volume is attached to the side of the spacer. In this fashion, a vacuum drawn at (14) creates an airflow from inside the adaptor shaft, through the opening and into the box and out the vacuum connection. The endplates and the spacer are designed to be easily disassembled for cleaning of the inside components. The entire power head assembly shown in FIG. 2 is mounted on a powered (motor and drive not shown) linear slide (15) that moves axially. FIG. 8 shows the cutter tube (FIG. 1) mounted in the power head (FIG. 2). A removable attachment pin or other type devise (16) secures the boring tube (1) in the adaptor shaft (8).

The boring tube (1) is designed to slide snugly into the adaptor shaft (8) without blocking the air holes in the adaptor shaft. Releasing the pin or other type devise enables the boring tube to be removed and cleaned, sharpened or replaced with another size as desired.

The entire power head assembly is mounted on a powered linear slide (15).

The slide moves the power head (and attached cutter mechanism) in the axial direction (parallel to the long axis of the cutter tube). Operation of this slide moves the end cutter into and out of the roll creating a cylindrical cavity.

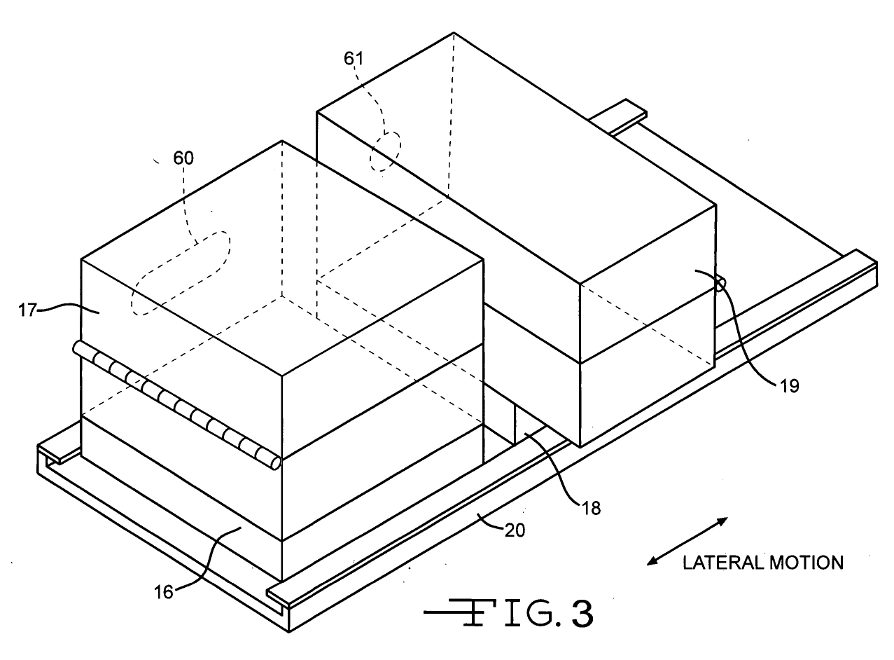

FIG. 3 is a representation of two nest assemblies suitable for the cutting of round and long rolls (rolls not shown). Each nest is designed to securely hold one roll during the cutting process. Each nest has a base (16) or (18) that supports the rolls and a clamping component (17) or (19) that orients, positions and clamps the roll in the required location. The clamping action keeps the roll from moving relative to the nest as the cutter bores the cavity in the roll. The clamping action also ensures that the cavity is accurately cut in the desired portion of the roll through desired apertures 60, 61.

The nests are preferably mounted on a powered (motor and drive not shown) linear slide (20) that moves the nests in a lateral direction (relative to the axis of the boring tube). Movement of the lateral slide during the cutting process produces an oval cavity in the roll. The lateral slide also moves to transport the nests from the loading to unloading positions (not shown).

Multiple nests and power heads are used to increase the production rate of the cutter machine as required.

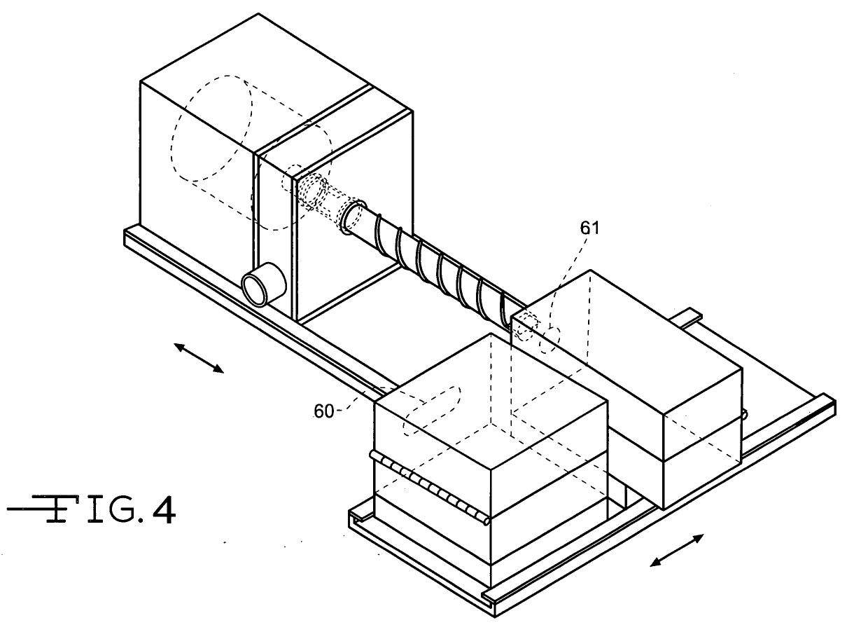

FIG. 4 shows the orientation of one power head and two nests. The axial motion of the power head and the lateral motion of the nests are also shown.

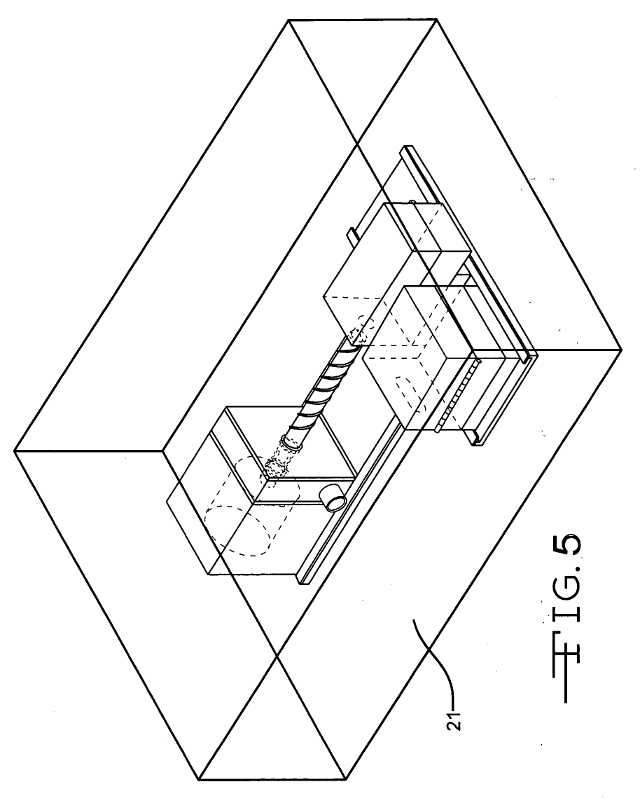

The cutter station is temperature controlled (mechanism not shown) to keep the rolls in a frozen condition. FIG. 5 shows a typical enclosure (21) that houses the power head and nests. The enclosure is insulated to repel heat from outside the cutter station. The cut and uncut roll inventory (not shown) is stored under the unit as is the vacuum (not shown), air filter systems (not shown), nest loading and unloading systems (not shown) and control system (not shown).

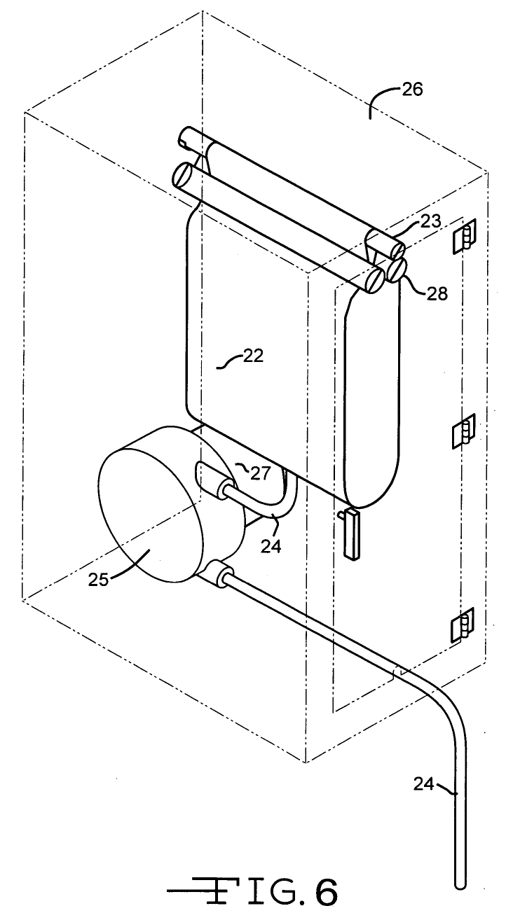

FIG. 6 depicts the filling station. The filling station takes a preset quantity of prepared filling and pumps it into the cavity that was created in the roll. The bladder (22) is filled with a prepared filling. A long filling tube (24) extends from the bottom of the bladder through a peristaltic style pump (25) to the outside of the filling station enclosure (26). The flexible tube (hose) extends sufficiently so that the open end of the tube can be placed at the bottom extreme of the roll cavity. An electric motor (27) rotates the pump a predetermined number of turns causing it to dispense the desired quantity of filling. The use of a peristaltic pump permits solid objects (i.e. meat cubes, beans or chocolate chips) in the filling to be pumped into the roll cavity. The operator withdraws the roll as the filling is being discharged from the tube into the roll cavity.

The peristaltic pump stops rotating at the end of the filling cycle preventing any additional filling from being discharged from the tube. Sliding rollers move down the bladder as the peristaltic pump withdraws the filling. The rollers squeeze the filling down the bladder towards the bottom ensuring that the all the filling is removed as the bladder is emptied. The rollers also create a continuous flow of filling to the pump and ensure that a positive pressure exists at the pump inlet. The use of a bladder with the rollers and a peristaltic pump eliminates the need to open the bladder and eliminates the possibility of the filling coming in contact with any of the parts of the machine. The filling station is temperature controlled (not shown) to keep the filling material fresh and ready for use. A control system (not shown) controls the operation of the pump and temperature of the system. Multiple filling stations are used to offer a variety of filling options to the customer.

The rolls grilled or not grilled and/or desert products can also be filled by conventional methods similar to a baker's syringe and/or pastry bag with desired sized opening.

In operation, the operator selects a roll from the pre-cut grilled inventory; the operator removes the selected type of roll. The operator then inserts the nozzle into the grilled roll cavity and starts the filling operation by pressing a button or other sensor (not shown). The filling sequence is automatically completed by the pump and control system. The grilled roll is then given to the customer.

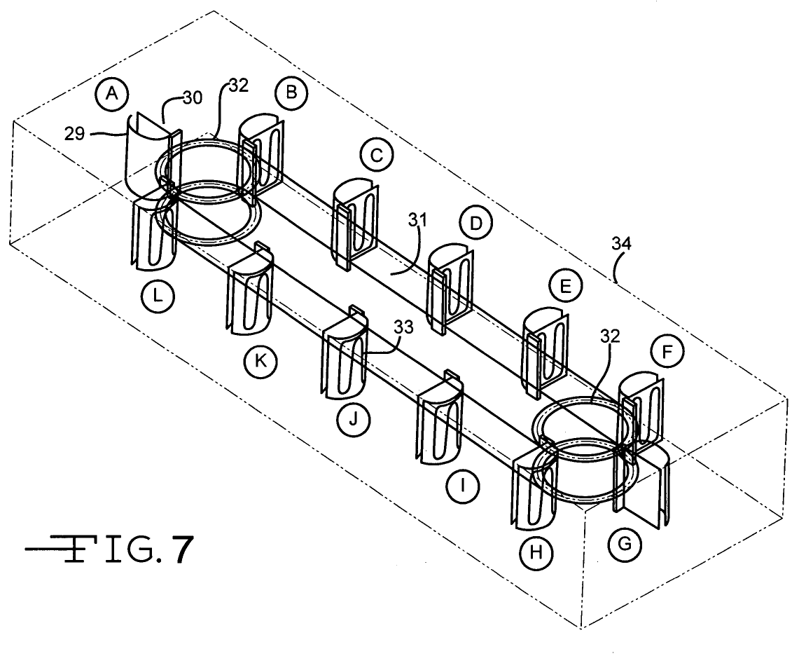

FIG. 7 shows the grilling station. The rolls are grilled in individual clamshell-like nests that securely hold each roll as they travel through the grilling station. Each nest has a moveable top shell (29) and a fixed bottom shell (30) that is attached to a moving belt (31). Two sheaves (32) support the continuous belt and permit it to move in an oblong path. A variable speed motor (not shown) powers one sheave causing it to rotate and thereby causing the belt and attached nests to move.

Internal electric (wiring not shown) resistance heaters (33) heat each of the two shells that comprise the nest. Additional heating (not shown) within the insulated enclosure (34) also heats the nests. The temperature of each shell is maintained at the level required to heat each type of roll. The clamshells also have raised ridges (not shown), similar to those found on flat grills, which contact the roll and impart darkened grooves in the roll surface similar to those created on flat grills.

Rolls enter the grilling station through an automatic door (not shown) at point A. They are placed in the open nest by a loading device (not shown) that places a roll (with the open side facing up) between the open shells. A stop (not shown) holds the roll in the vertical and/or horizontal position depending on application while the shells are separated. A cam (not shown) holds the shells open during the loading sequence. Springs (not shown) close the clamshell halves as the nest moves away from position A towards position B. The springs create sufficient pressure on the shells to enable them to securely hold various sizes of roll without crushing them. The nest continues from position B to C then D etc. as the belt travels around the sheaves. Doors (not shown) at positions H through L permit rolls that do not require the full heating cycle to be removed from the grilling station. The rolls are removed by operating a cam (not shown) that opens the clamshell and the adjacent exit door. Opening the clamshell permits the heated roll to fall out the bottom of the nest, through the open door and down a slide (not shown) that exits the bottom of the grilling station. The door and clamshell re-close after the roll has exited. All rolls must exit before or at position L. Grilled rolls automatically slide into thermostatically controlled warming drawers.

The above examples are intended to illustrate the invention and it is to be understood that the invention can be carried out with many modifications, adaptations and variations, without departing from its spirit or exceeding the scope of the claims.

We claim:

1. An apparatus for cutting a yeast and/or yeast-like and/or leaven containing product comprising:
a positioning device for receiving at least one yeast and/or yeast-like and/or leaven containing product;
a boring conduit having a distal end and a proximal end, the proximal end is attached to a motor that allows the distal end to at least penetrate into and out of the at least one yeast and/or yeast-like and/or leaven containing product on the positioning device to form at least the outer perimeter of a cavity within the at least one yeast and/or yeast-like and/or leaven containing product;
a negative pressure is maintained within the boring conduit and removes at least some of the material within the outer perimeter of the cavity.

2. The apparatus of claim 1 wherein the negative pressure is formed by a vacuum device.

3. The apparatus of claim 1 wherein at least one blade is positioned at the distal end.

4. The apparatus of claim 3 wherein the at least one blade is also positioned on the exterior surface of the boring conduit.

5. The apparatus of claim 1 wherein the boring conduit has apertures.

6. The apparatus of claim 3 wherein the at least one blade is formed from the boring conduit.

7. The apparatus of claim 1 wherein the at least one yeast and/or yeast-like and/or leaven containing product is frozen or partially frozen.

8. The apparatus of claim 1 wherein the positioning device moves to enlarge the size of the cavity.

9. The apparatus of claim 1 wherein the boring conduit moves to enlarge the size of the cavity.

10. The apparatus of claim 1 wherein the apparatus operates in a refrigerated environment.

11. The apparatus of claim 1 wherein the apparatus further has a vacuum device to form the negative pressure, a refrigeration apparatus, and by-product collection apparatus that collects the at least some of the material within the outer perimeter of the cavity.

12. The apparatus of claim 1 wherein the cavity is filled with an edible food product.

13. The apparatus of claim 12 wherein the edible food product is in a frozen or thawed state.

14. The apparatus of claim 12 wherein the at least one yeast and/or yeast-like and/or leaven containing product can be any size or dimension that is greater than the cavity's size or dimension.

15. The apparatus of claim 1 further comprising a filling unit to fill the cavity with an edible food product filling.

16. The apparatus of claim 15 wherein the filling unit injects food that is in a fluid and/or quasi-fluid state through a tube into the cavity.

17. The apparatus of claim 15 wherein the filling unit device contains at least one vessel for holding the edible food product filling.

18. The apparatus of claim 15 further comprising temperature control elements to maintain a constant temperature of the food product filling.

19. The apparatus of claim 1 further comprising a griller that grills at least one side of the at least one yeast and/or yeast-like and/or leaven containing product.

20. The apparatus of claim 19 wherein the griller further comprises a dispenser that directs the at least one yeast and/or yeast-like and/or leaven containing product into a warmer draw.
